(19) United States
(12) Patent Application Publication
(10) Pub. No.: US 2007/0103581 A1
(43) Pub. Date: May 10, 2007

(54) Scanning imaging system and method for imaging articles using same

(75) Inventors: John F Dwinell, Wrentham, MA (US); Jeffrey S. Bernstein, Sudbury, MA (US)

Correspondence Address: FOLEY AND LARDNER LLP;SUITE 500, 3000 K STREET NW, WASHINGTON, DC, 20007, US

(73) Assignee: SICK, INC.

(21) Appl. No.: 10/579,391

(22) PCT Filed: Oct. 22, 2004
(86) PCT No.: PCT/IB04/04399

§ 371 Date: May 15, 2006

Related U.S. Application Data
(60) Provisional application No. 60/519,616, filed on Nov. 14, 2003.

(51) Int. Cl. G03B 13/00

(52) U.S. Cl. 348/345

(57) ABSTRACT

An imaging system includes a line-scan camera (8) having an image line in an planar imaging beam path and a depth of focus. Line forming optics are arranged between at least two arrays of LEDs (4,6) and the image object so as to form two respective illumination stripes in two planar illumination beam paths (5,7). The planar imaging beam path (9) is located between the two or more planar illumination beam paths (5,7). The planar imaging beam path (9) and the two planar illumination beam paths (5,7) preferably intersect proximate to the far depth of focus of the camera. The image line and illumination stripes are parallel across an image area, which may comprise a transport device, such as a conveyor. The non-coplanar planar illumination beam paths provide maximum overlap at the farthest depth of field where illumination is most needed and diverge closer to the camera.

The present invention relates to a scanning imaging system, in particular, a line-scan camera system having a LED illumination system. The invention further relates to a method for imaging articles using a scanning imaging system having a LED illumination system.

Optical scanning systems are widely used for reading and decoding bar codes and other symbols provided on objects. For example, line-scan cameras using charge coupled devices (CCDs) may be used to image objects as they move along a conveyor or other transport device. In such systems, illumination is very important to the quality of the acquired image. Higher intensity light is necessary as transport speed or speed of the sensor increases since the effective exposure time decreaese.

Until recently, optical scanning systems commonly used sodium vapor lamps for illumination. These lamps provide a great deal of light, thereby enhancing image quality. On the other hand, sodium vapor lamps have several undesirable qualities. For example, they produce a large amount of heat. Further, they require a large amount of power (which also causes generation of heat). Additionally, sodium vapor lamps are typically not directional. Consequently, they flood work areas with unwanted, blinding light that often requires shielding.

Recent improvements have resulted in light emitting diodes (LEDs) with high irradiance. This provides the opportunity for LED-based illumination systems. One such LED-based illumination system is described in U.S. Pat. No. 6,628,445-B2.

U.S. Pat. No. 6,628,445-B2 discloses systems in which a cylindrical lens is positioned between a light source comprising an array of LEDs and an object to be scanned. The cylindrical lens collects, transmits and focuses light from the LEDs to form an illumination stripe. The linear array sensor, lens axis and illumination stripe are coplanar and parallel. In one embodiment, a single, movable array of LEDs is positioned to focus a strip of light at different positions along the camera axis.

The system of U.S. Pat. No. 6,628,445 B2 is restricted to small variations in positioning the focus and in practice gives little illumination outside the focus. Therefore problems arise when labels on low and high packages have to be read by the camera, so that the labels have different distances to the camera.

In view of the foregoing, it would be desirable to provide an economical and efficient scanning imaging using LED-based illumination.

According to one aspect of the invention, an imaging system includes a line-scan camera having an image line in an image planar imaging beam path and a depth of focus. Line forming optics are arranged between at least two arrays of LEDs and the image object so as to form two respective illumination stripes in two planar illumination beam paths. The two illumination beam paths provide for much more illumination than a single one. This is not only the case at the intersection line defined by the intersection of the two planar illumination beam paths, but it is especially advantageous when the planar imaging beam path is located between the two planar illumination beam paths.

The planar imaging beam path and the two planar illumination beam paths preferably intersect proximate to the far depth of focus of the camera. The image line and illumination stripes are parallel across an image area, which may comprise a transport device, such as a conveyor.

The planar illumination beam paths diverge as they extend through the depth of focus toward the camera. Thus, at a point between the near depth of focus and the LED arrays, the illumination stripes diverge. The illumination stripes intersect and overlap the planar imaging beam path through the depth of focus. This configuration is referred to as a bi-planar arrangement.

It is especially advantageous when the first and second illumination planes converge in such a way that the increasing brightness within the image plane due to the increasing overlap of the illumination planes compensate roughly for the decrease in image illumination due to the increasing distance. Thus the invention system provides for much better illumination within a greater depth resulting in better recognition abilities, like decoding rates, scan rates etc.

According to another aspect of the invention, an object to be imaged is conveyed along a transport device, such as a conveyor. The object enters the planar imaging beam path of a line-scan camera. The object is illuminated with at least two illumination stripes formed by line-forming optics disposed between the object and at least two arrays of LEDs. The planar imaging beam path is preferably centered between planar illumination beam paths formed by the LED arrays. The planar imaging beam path and the two planar illumination beam paths preferably intersect proximate to the far depth of focus of the camera.

Alternative embodiments include multi-planar arrangements with more than two illumination sources.

According to one feature of the invention, each light source comprises an LED array and line forming optics, such as a Fresnel lens or a lenslet array. Alternatively, LEDs with integrated optics, such as Luxeon lines, may be used.

In one preferred embodiment of the invention, the light arrays and collimating optics are provided on either side of the planar imaging beam path.

If the camera of the system comprises autofocussing means the depth of focus can be greatly enhanced and due to the biplanar arrangement the illumination is still sufficient throughout the enlarged depth of focus.

Other features and advantages of the invention will be apparent from the following description of preferred embodiments of the invention.

In the drawings:

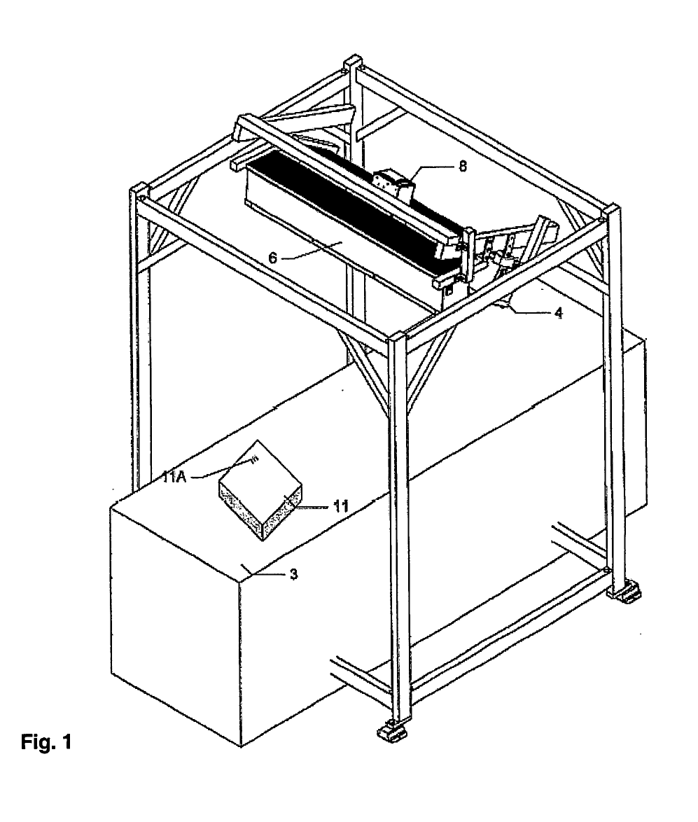

FIG. 1 is a perspective view of a scanning imaging system according to an embodiment of the present invention.

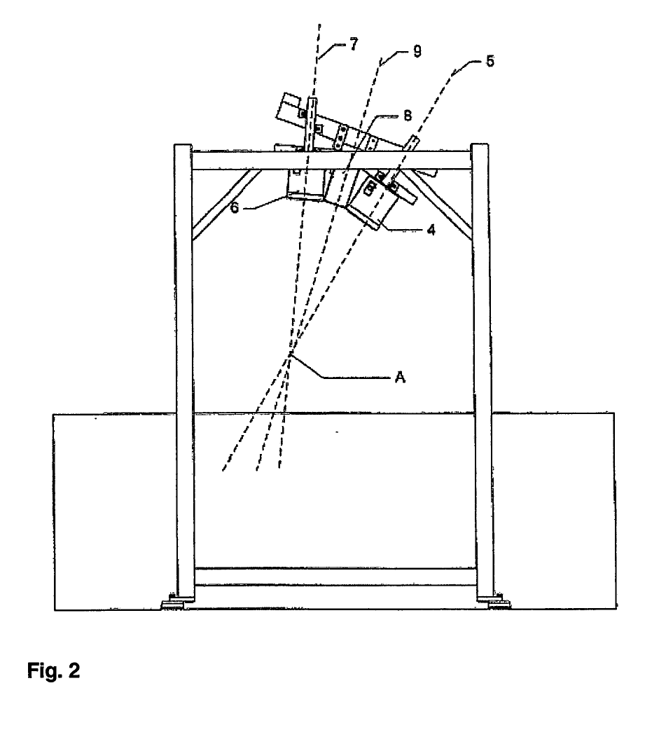

FIG. 2 is a side plan view of the scanning imaging system of FIG. 1.

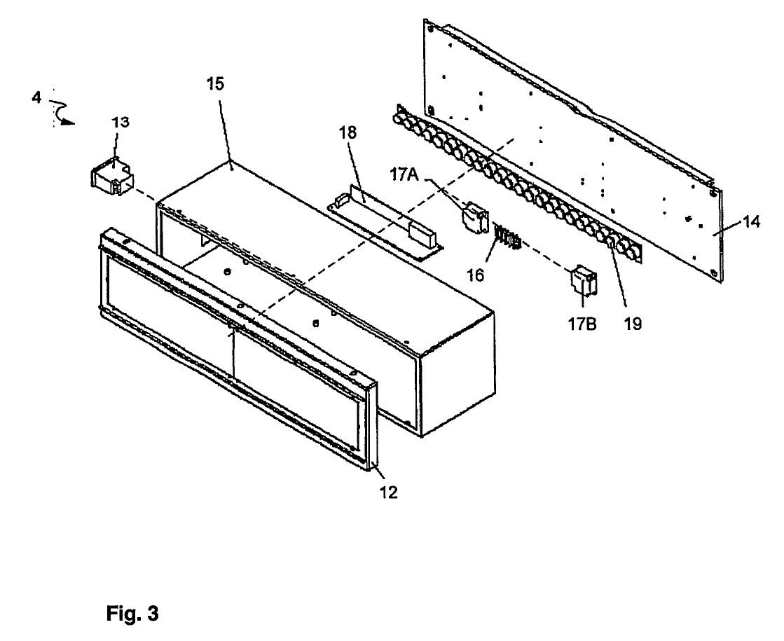

FIG. 3 is an exploded perspective view of a light source as used in the scanning imaging system of FIG. 1.

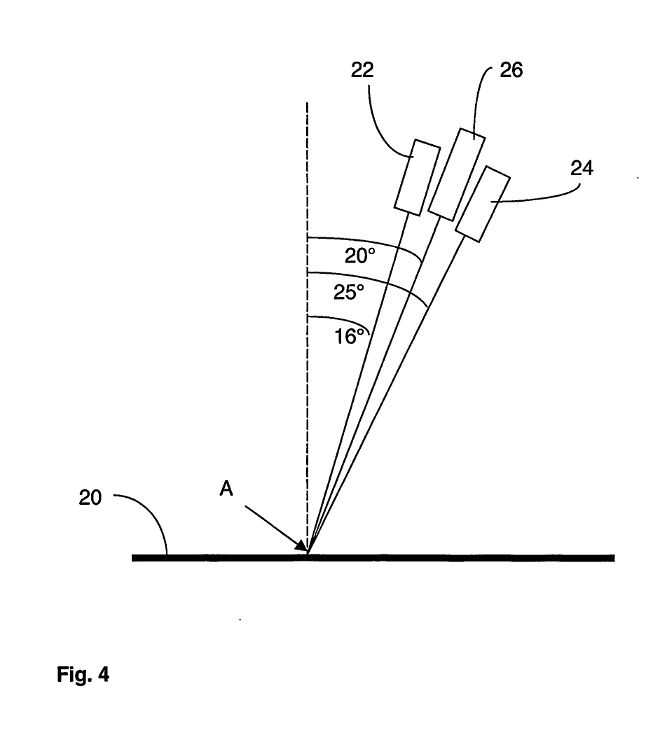

FIG. 4 is a side view illustrating the respective positions of an imaging system according to another embodiment of the invention.

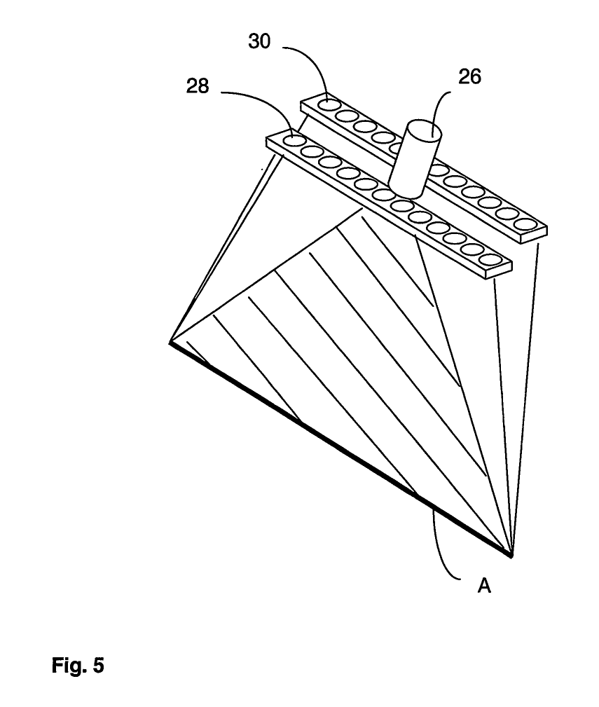

FIG. 5 is a side view illustrating two sets of lenses 28, 30 that may be used to form non-coplanar light beams as part of the light sources shown in FIG. 4.

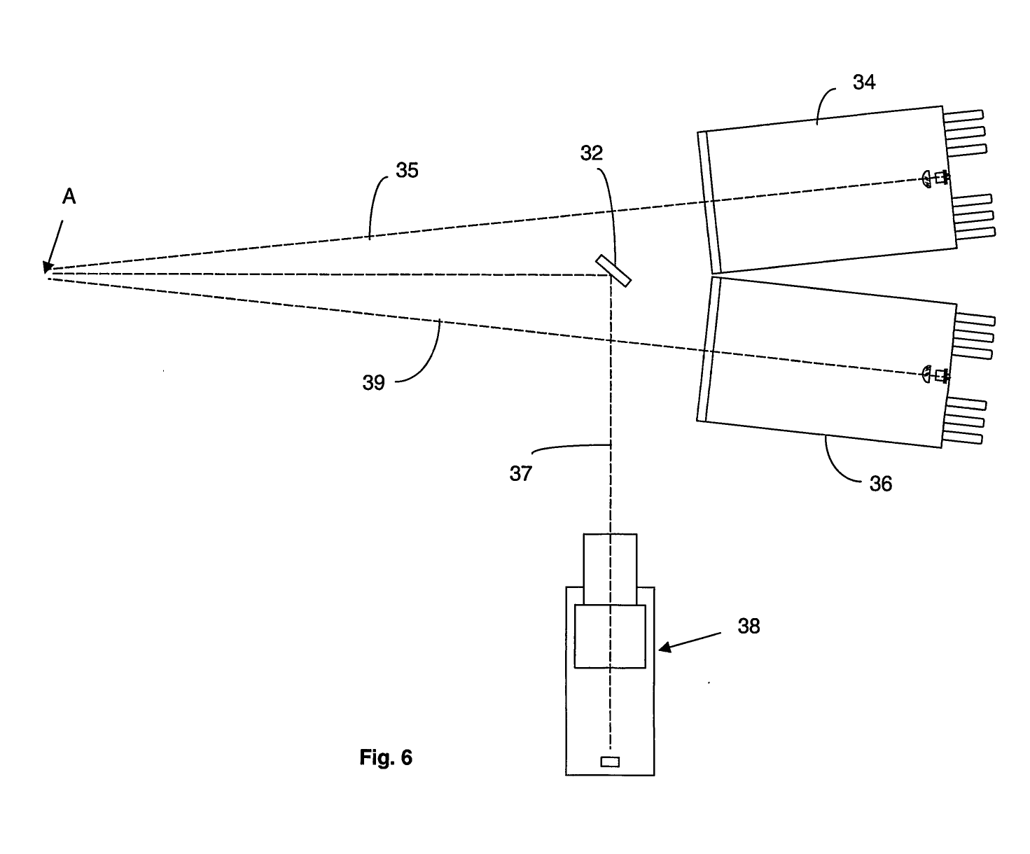

FIG. 6 is a perspective view of a scanning imaging system according to another embodiment of the invention.

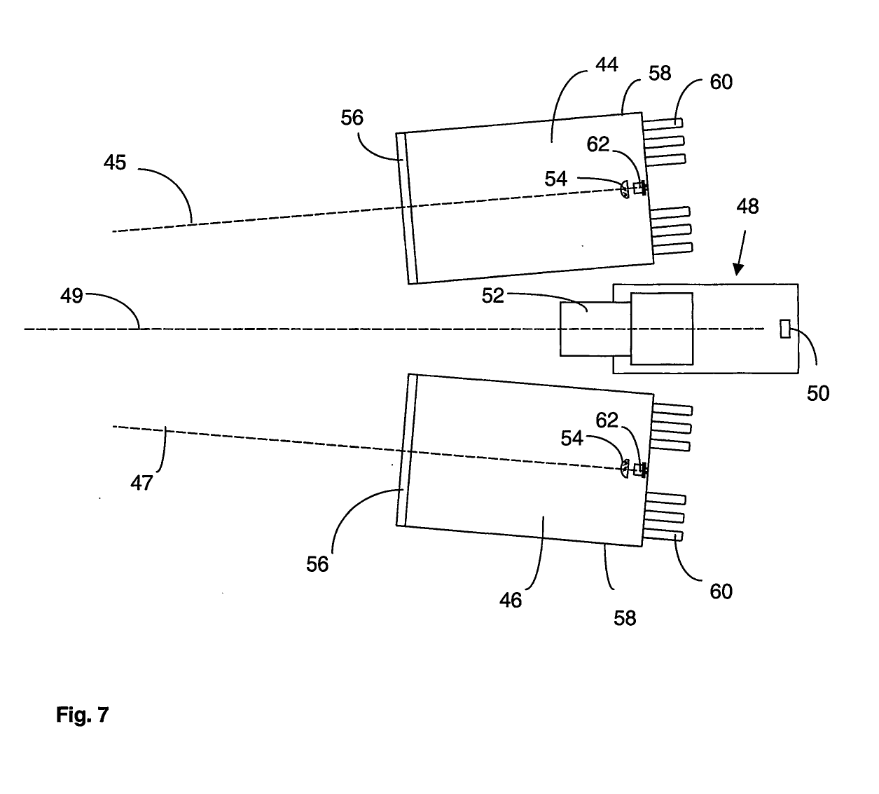

FIG. 7 is a center cross sectional view of a scanning imaging system according to another embodiment of the invention.

FIGS. 1 and 2 illustrate a scanning imaging system according to an embodiment of the invention. A line-scan camera 8 is provided above a transport device, such as a conveyor 3, which is adapted to move articles to be imaged in a horizontal plane below the line-scan camera. Merely for purposes of illustration, the articles may include a package 11 having on its surface a bar code 11A to be scanned and imaged.

In this example, the camera 8 is a CCD line-scan camera of a type known in the art, such as that disclosed in U.S. Pat. No. 6,104,427, the disclosure of which is hereby incorporated by reference. The CCD line-scan camera may include focusing elements and a linear imaging array. The camera 8 and associated optics can vary based on particular applications, and various designs according to the invention are possible. It will be understood that the camera may include associated electronics to receive output from the CCD and to control operation of the camera. Specific description of the camera, optics and associated electronics is therefore unnecessary.

A first light source 4 is provided below the camera 8 and a second light source 6 is provided above the camera 8. The light sources 4, 6 comprise LED arrays with collimating optics, which produce highly collimated beams in respective planar illumination beam paths 7 and 11. As illustrated, the planar illumination beam paths 7 and 11 are not co-planar.

FIG. 3 illustrates the light source 4 in more detail (light source 6 is identical in this example). The light source 4 includes a Luxeon LED board 19, which comprises a row of LEDs and integrated collimating lenses. Optionally, a row of LEDs and a Fresnel lens may be used. As known in the art, the Luxeon LED board is connected to a pair of LED drivers 17A, 17B, and a terminal block 16. Power is supplied through an AC-DC converter 18 and a power entry module 13. The optical and electronic components are housed in an enclosure 15 with cover 12 and rear sink 14.

The light sources 4, 6 each produce beams that are preferably somewhat telecentric. Accordingly, it is desirable that the light sources 4, 6 produce beams having widths corresponding at least to the width of the image area. The use of a line of LEDs and suitable collimating optics allow for adjustment of the width of the beams, which makes the thermal management more efficient. Such lamp design also attains a uniform mixing of the LEDs across the image field in a very short distance. The relative width of the illumination lines may, of course, vary depending on the particular application. The high irradiance of the light sources is particular useful for high-speed applications.

As illustrated in FIG. 2, the light sources 4, 6 and camera 8 are preferably oriented so that the planar imaging beam path 9 and planar illumination beam paths 5, 7 intersect at a line A. Preferably, this line A is substantially near the farthest depth of field of the camera 8. Although line A is shown in FIG. 2 as being somewhat above the surface of the conveyor 3, in practice, the light sources and camera will be configured so that the farthest depth of field and the intersection of the planar illumination beam paths will preferably fall at the surface of the conveyor.

It will be appreciated that the planar illumination beam paths 5, 7 overlap at the far depth of field. Moving up the planar imaging beam path 9 closer toward the camera 8, the planar illumination beam paths 5, 7 diverge. Thus, closer to the camera 8, each light source 5, 7 contributes less illumination, but less is needed since the distance to the camera is smaller. The light sources 4, 6 and camera 8 are oriented to provide maximum overlap at the farthest depth of field where the most illumination is needed.

In operation, an object to be imaged, such as package 11, is conveyed along conveyor 3. As the package 11 reaches the planar imaging beam path of the line-scan camera 8, the package 11 is illuminated with two illumination stripes formed by light sources 4, 6. As noted above, the planar imaging beam path 9 is preferably centered between planar illumination beam paths 5, 7 formed by the LED light sources 4, 6. Light from the LED light sources 4, 6 is reflected from the package 11 and is received by the camera 8. An image from the light sensors in camera 8 is processed by associated electronics according to techniques known in the art.

FIG. 4 is a side view showing one preferred orientation of light sources 22, 24 and a camera 26. As shown in FIGS. 1 and 2, the light sources 22, 24 provide planar illumination beam paths that intersect at a line A. Line A is disposed on a surface 20 that falls at a farther end of the depth of focus of camera 26. In this example, the respective planar illumination beam paths of light sources 22 and 24 are inclined at an angle of 16° and 25° from the vertical plane, and the planar imaging beam path of camera 26 is inclined at an angle of 20° from vertical. While a system according to the invention could be designed so that the imaging plane is vertical, it has been found that an offset angle, such as illustrated in FIG. 4, avoids spectral reflections. An offset of the planar imaging beam path of at least 8°-15° from vertical reduces spectral reflection. A greater offset of 20° (as illustrated in FIG. 4), for example, reduces spectral reflection by an even greater degree. It will be appreciated that the relative angle between the planar illumination beam paths and the image field may be adjusted to adapt for a desired increase or decrease the depth of field.

FIG. 5 illustrates two sets of lenses 28, 30 that may be used to form non-coplanar light beams as part of the light sources 22, 24 of FIG. 4. In this example, an array of LEDs (not shown) are formed in a line. Each LED acts as a point source. The line of LEDs are surrounded by reflectors (not shown) and so that the light from the LEDs is gathered and reflected onto and through the lenslet arrays 28, 30. Such arrangement provides highly collimated beams with little expense. Again, various types of LEDs and collimating arrangements can be used as a light source depending on particular design requirements.

FIG. 6 illustrates yet another embodiment in which a first light source 34 and a second light source 36 are arranged proximate to a turning mirror 32. The turning mirror forms part of the optical path 37 of a line scan camera 38. As shown, the optical path 37 is disposed between the illumination planes 35 and 39 of the light sources 34, 36. The light sources in this example comprise LED arrays with collimating optics that produce illumination substantially in the planes 35 and 39. The illumination planes 35, 39 converge at a point A that is proximate to the far depth of field of the camera 38.

FIG. 7 shows an embodiment of the invention in somewhat more details. A cross section through the center of the system is shown. First and second light sources 44 and 46 are provided next to the camera 48 with their longitudinal extension extending perpendicular to the plane of drawing. The illumination planes 45 and 47 created by the light sources and the image plane 49 extend also perpendicular to the drawing plane. Camera 48 is disposed between the light sources and comprises a linear sensor array 50 with its linear dimension extending again perpendicular to the drawing plane. The camera 48 further comprises camera optics 52. The camera may include means for autofocussing including a distance measurement device which are both not shown. Such devices are known from prior art and can include means to move a lens of the camera optics, means to move the sensor array or means to move a further optical element like a mirror between the optics and the sensor array.

The sensor array is aligned parallel to the intersection line A and surface 3. The light sources 44 and 46 are also parallel to the sensor array 50 and comprise rows of LEDs 62 as already described. The light of the LEDs 62 is preferably diffused by first lenses 54 in the longitudinal direction to enhance overlap of the light of adjacent LEDs 62 and than collimated in the perpendicular direction by cylindrical lenses 56 to form the said illumination stripes. At the back of light source housings 58 cooling rips 60 are disposed which build heat sinks.

It will be appreciated that the present invention provides many advantages. It provides superior and more uniform irradiance throughout the depth of field of a camera. This is particularly desirable for high speed and OCR applications. In particular, it provides maximum overlap of two beams at the farthest depth of field and divergence of the two beams from the planar imaging beam path as they approach the camera. Thus, as objects having surfaces of varying heights fall within different positions within the depth of field of the camera, adequate illumination is provided.

The invention allows the use of less expensive and easier to use LED elements. In particular, the use of conventional LEDs and optics may provide necessary illumination when used in a non-coplanar design according to the invention. Irradiance of, for example, up to 160 w/m² may be provided using LED lamps according to the invention. In contrast, co-planar sources typically require LEDs that must be bunched more closely together to provide adequate light levels. Off-the-shelf LEDs with integrated light capturing optics that provide suitable illumination may not be available, however. As a result, co-planar systems may require custom optics, which may not be as efficient or economical as off-the-shelf LED sources.

Another advantage of the invention is that it enables the LED source to be located at a turn mirror that conventionally forms part of the image path. This results in the lamp being closer to the reading field. By being closer to the reading area, the amount of light needed for illumination is reduced. This saves power and reduces generation of heat.

Further, the present invention does not require a complex or expensive illumination turn mirror. In contrast, conventional coplanar designs located at the camera source may require a very large turn mirror that turns the illumination. While the mirror quality for the illumination can be of a low quality, the image mirror must be a very high quality mirror. This complicates the construction of the combined mirror requirements. Having the illumination located above and below the image turn mirror eliminates this problem.

The lamp construction of the invention, preferably, forms a highly collimated beam that is somewhat telecentric. This maintains the irradiance through the depth of field. Coplanar lamp designs that provide radially expanding (i.e., non-telecentric) beams require that the beam at the far depth of field be much longer than necessary with the lamp design of the preferred embodiment of the invention, in order to be sufficiently wide at the near depth of field. The result is that the irradiance decreases at the father depths of field. Extra power is thereby required in order to make up for this loss.

Additionally, it has been found that by mounting the illumination at the turn mirror rather than the camera, it is possible to avoid requiring complex mechanical construction of the camera. Traditional coplanar designs may require complicated folding mirrors or a slotted Fresnel lens and careful alignment with the camera CCD axis. Such complicated camera construction presents undesirable maintenance issues and makes system installation more difficult.

As noted above, it has been found that an LED lamp design that is wide as the image field offers several advantages. It allows for spacing of the LEDs that is wide enough to make the thermal management more efficient. It also facilitates uniform mixing of the LEDs across the image field in a very short distance. Other lamp designs may have a bifurcated irradiance close to the LED source.

It will also be appreciated that the use of an optic that is collimated on two axes and then formed into a line with a separate optic provides a very high collection efficiency. By combining this design approach with the bi-planar construction provides the optimal irradiance at the far depth of field, where it is needed most.

It will be appreciated that bi-planar designs according to the invention may be implemented in various manners to provide very low cost solutions for lower speed applications. Such designs include a collimating reflector-based design with a cylindrical lenslet array. Further, it is possible to construct systems with more than two off-axis illumination sources. A single light sources could also be collimated with separate optics to form the two or more illumination paths.

While preferred embodiments of the invention have been described in detail, the invention is not so limited. Various modifications will be apparent to those skilled in the art without departing from the spirit and scope of the invention. For example, different configurations of light sources and cameras may be used. Furthermore the invention may be implemented in different applications.

1. An imaging system comprising:
a camera adapted to receive an image line in an image plane and a depth of focus;
a first light source and a second light source configured to provide illumination in first and second respective illumination planes, said first and second illumination planes converging at a position within the depth of focus of the camera.

2. An imaging system according to claim 1, wherein the image plane is disposed between the first and second illumination planes.

3. An imaging system according to claim 1, wherein an intersection line defined by the intersection of the converging first and second illumination planes is parallel to the image plane.

4. An imaging system according to claim 1, wherein the first and second illumination planes converge proximate to a far depth of focus of the camera.

5. An imaging system according to claim 1, wherein the first and second illumination planes converge in such a way that the increasing brightness within the image plane due to the increasing overlap of the illumination planes compensates roughly for the decrease in image illumination due to the increasing distance.

6. An imaging system according to claim 1, wherein the camera is a line-scan camera.

7. An imaging system according to claim 4, wherein the line-scan camera comprises a linear sensor array, preferably a CCD sensor array.

8. An imaging system according to claim 1, wherein the crossing line is parallel to the sensor array of the camera.

9. An imaging system according to claim 1, wherein the first and second light sources each comprise an array of LEDs and collimating optics adapted to form a substantially planar beam of light.

10. An imaging system according to claim 6, wherein the collimating optics include a cylindrical lens.

11. An imaging system according to claim 6, wherein the collimating optics include diffusing lenses for each LED.

12. An imaging system according claim 1, wherein the camera is adapted to scan a line image of an object.

13. An imaging system according claim 1, wherein the camera comprises camera optics including means for autofocussing.

14. An imaging system according claim 1, wherein the means for autofocussing include distance measuring means.

15. An imaging system according to claim 1, for acquiring an image of a three dimensional object, comprising
a transport system, e.g. a conveyor, to move the object passed the imaging system,
an evaluation unit for acquiring the complete image after the object has passed the scanning region.

16. A system according to claim 13, wherein the evaluation unit comprises a volume measurement unit.

17. A system according to claim 13, wherein the evaluation unit comprises a compression unit for compression of image data.

18. A system according to claim 13, wherein the evaluation unit comprises a decoding unit for decoding a code within the image and/or optical character recognition.

19. A method of imaging an object comprising:
providing an object to be imaged;
scanning a surface of the object with an imaging system according to claim 1.
